(19) United States
(12) Patent Application Publication
(10) Pub. No.: US 2013/0298470 A1
(43) Pub. Date: Nov. 14, 2013

(54) Window channel lining for land rovers

(71) Applicant: Paul Shkut, Valley Village, CA (US)

(72) Inventor: Paul Shkut, Valley Village, CA (US)

(21) Appl. No.: 13/506,709

(22) Filed: May 11, 2012

(51) Int. Cl. B60J 10/04

(52) U.S. Cl. 49/490.1

(57) ABSTRACT

Improved window channel liners for Land Rover vehicles which liners are formed of rubber and which are formed with ridges to prevent the liners from coming out of the channels and create a buffer between the window glass and the channel to prevent rattling.

### FIELD OF INVENTION

This invention relates to automotive equipment and is particularly directed to improved window channel linings for Land Rover vehicles and the like.

### BACKGROUND

In many vehicles, especially sport utility vehicles, such as the Land Rover Defender model, the window frames are designed to be removable to allow better ventilation and to prevent breakage and rattling during off-road competition, racing or other vigorous activities. In many of these vehicles, the removable window frames include two separate glass windows which are slideable within parallel channels. To prevent the window glass from rattling, felt liners are provide within the window channels. However, over time and due to environmental conditions, these felt liners compress, harden, rot and degrade allowing the window glass to rattle. Thus, none of the prior art window channel liners have been entirely satisfactory.

### BRIEF SUMMARY AND OBJECTS OF INVENTION

These disadvantages of the prior art are overcome with the present invention and improved window channel liners are provided which cushion the window glass during opening and closing of the vehicle doors and create a buffer between the window glass and the channel to prevent rattling.

These advantages of the present invention are preferably attained by providing improved window channel liners formed of rubber and having ridges to prevent the liners from coming out of the channels.

Accordingly it is an object of the present invention to provide improved window channel liners for vehicles.

Another object of the present invention is to provide improved window channel liners for Land Rover vehicles.

An additional object of the present invention is to provide improved window channel liners for Land Rover vehicles which liners are formed of rubber.

A further object of the present invention is to provide improved window channel liners for Land Rover vehicles which liners are formed of rubber and create a buffer between the window glass and the channel to prevent rattling.

A specific object of the present invention is to provide improved window channel liners for Land Rover vehicles which liners are formed of rubber and which are formed with ridges to prevent the liners from coming out of the channels and create a buffer between the window glass and the channel to prevent rattling.

These and other objects and features of the present invention will be apparent from the following detailed description, taken with reference to the figures of the accompanying drawings.

### BRIEF DESCRIPTION OF THE DRAWINGS

FIG. 1 is a vertical section through a window slide channel showing a channel lining embodying the present invention.

### DETAILED DESCRIPTION OF THE INVENTION

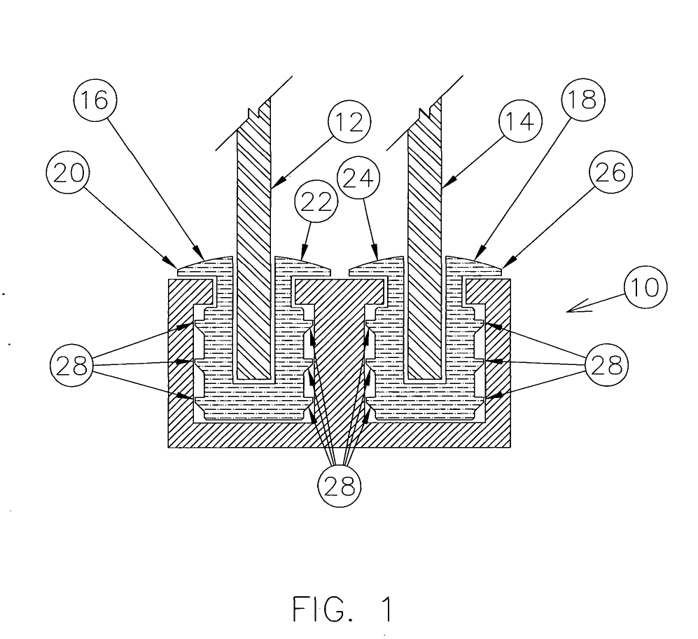

In that form of the present invention chosen for purposes of illustration, FIG. 1 shows a window slide channel, indicated generally at 10, having a pair of windows 12 and 14 slideably mounted therein. A pair of rubber linings 16 and 18 are mounted within the slide channel 10 to facilitate movement of the windows 12 and 14 within the slide channel 10 and to form a buffer between the window and the frame to cushion the windows 12 and 14 against vibration, jarring and the like. As shown, the linings 16 and 18 are generally U-shaped and have flanges 20, 22, 24 and 26 which overlie the adjacent portions of the slide channel 10 to prevent rain or other moisture from entering the slide channel 10 to cause rusting. Also. The linings 16 and 18 are formed with ridges 28 or teeth which project outwardly from the sides of the linings 16 and 18 to engage the inner walls of the slide channel 10 to prevent the linings 16 and 18 from becoming dislocated.

The linings 16 and 18 serve to facilitate movement of the windows 12 and 14 along the slide channel 10 and to prevent rattling, vibrating and damage from sudden jolts. Also, because the linings 16 and 18 are formed of rubber, they will withstand long exposure to the elements without deteriorating.

Obviously, numerous variations and modifications can be made without departing from the spirit of the present invention. Therefore, it should be clearly understood that the form of the present invention described above and shown in the accompanying drawing are illustrative only and are not intended to limit the scope of the present invention.

What is claimed is:

1. A lining for an automotive window slide channel comprising:
a generally U-shaped member formed of rubber insertable into said slide channel and receiving a window for sliding movement within said slide channel.

2. The lining of claim 1 further comprising:
said member having flanges overlying adjacent portions of said slide channel.

3. The lining of claim 1 further comprising:
said member having ridges projecting from the sides thereof for engagement with the inner walls of said slide channel.

4. The lining of claim 1 wherein:
said linings are mounted in the window slide channels of Defender models of Land Rover vehicles.

5. The lining of claim 1 wherein:
said lining creates a buffer between the window glass and the channel to prevent rattling.
